(19) United States
(12) Patent Application Publication
(10) Pub. No.: US 2020/0307879 A1
(43) Pub. Date: Oct. 1, 2020

(54) CLOSURE FOR A CASE

(71) Applicant: Hilti Aktiengesellschaft, Schaan (LI)

(72) Inventor: Kenth KARLSSON, Wasserburg (DE)

(21) Appl. No.: 16/765,502

(22) PCT Filed: Nov. 21, 2018
(86) PCT No.: PCT/EP2018/082016

§ 371 Date: May 20, 2020

(30) Foreign Application Priority Data
Dec. 21, 2017 (EP) 17209525.9

(51) Int. Cl. B65D 55/02; B25H 3/02; B65D 43/16

(52) U.S. Cl. CPC B65D 55/02; B65D 43/16; B25H 3/02

(57) ABSTRACT

Closure device containing a cover, a base, a first connection element, a second connection element and a locking element, the first and second connection element bearing at least partially against one another when the cover and the base bear against one another to close the storage container. The locking element can be positioned on the base so that, in the locking position, separation of the first connection element from the second connection element is prevented, and, in the release position, separation of the first connection element from the second connection element is allowed. The first connection element contains a first frontal plane, the second connection element contains a second frontal plane, and the locking element contains a third frontal plane, wherein the first and second frontal plane are oriented substantially parallel to one another, and the third frontal plane has a distance from the first and second frontal plane when the locking element is situated in the locking position.

The present invention relates to a closure device for a storage container, in particular a case, containing a cover element, a base element, a first connection element, a second connection element and a locking element, wherein the first connection element is positioned on the cover element and the second connection element is positioned on the base element in such a way that the first and second connection element bear at least partially against one another when the cover element and the base element bear against one another to close the storage container, and wherein the locking element can be positioned on the base element and reversibly in a locking position or release position, wherein, in the locking position, separation of the first connection element from the second connection element is prevented, and, in the release position, separation of the first connection element from the second connection element is allowed.

Moreover, the invention relates to a storage container, in particular a case, having at least one closure device.

### SUMMARY OF THE INVENTION

Storage containers, in particular cases, usually have one or more closure devices by means of which the opening of the storage container can be prevented or the secure closing of the storage container can be ensured. What is meant by opening of the storage container is essentially a separation or parting of a cover element of the storage container from a base element of the storage container such that a cavity between the cover element and the base element becomes accessible. For opening and closing the storage container, the closure device can be selectively correspondingly set either in a closure position or in an open position. A relatively simple and reliable embodiment of a closure device for a storage container is constituted by a latching or clip-on closure. In the case of such a latching or clip-on closure, a pivotable locking element is customarily clipped onto or against a connection element. The clipping of the pivotable locking element onto or against the connection element is made possible by an elastically bendable hook on the locking element that enters into a force-fitting connection with a corresponding mating piece on the connection element.

### SUMMARY OF THE INVENTION

However, the closure devices that are known from the prior art for storage containers, in particular for cases, present a problem. With a direct action of force (in other words: an impact) on the closure device as a result of the storage container being dropped, the closure devices move from the closure position into the open position, with the result that the storage container can be opened.

It is an object of the present invention to provide a closure device for a storage container and a storage container having at least one closure device by means of which the above-described problem can be solved and secure closure of the storage container in the event of it being dropped can be ensured.

The present invention provides a closure device for a storage container, in particular a case, containing a cover element, a base element, a first connection element, a second connection element and a locking element, wherein the first connection element is positioned on the cover element and the second connection element is positioned on the base element in such a way that the first and second connection element bear at least partially against one another when the cover element and the base element bear against one another to close the storage container, and wherein the locking element can be positioned on the base element and reversibly in a locking position or release position, wherein, in the locking position, separation of the first connection element from the second connection element is prevented, and, in the release position, separation of the first connection element from the second connection element is allowed.

According to the invention, there is provision that the first connection element contains a first frontal plane, the second connection element contains a second frontal plane, and the locking element contains a third frontal plane, wherein the first and second frontal plane are oriented substantially parallel to one another, and the third frontal plane has a distance from the first and second frontal plane when the locking element is situated in the locking position.

Here, the distance is chosen such that, with a sudden action of force on the closure device as a result of the storage container being dropped onto a hard surface, the locking element can undergo a certain deformation or a certain movement (without a deformation of the locking element) in the direction of the first and second connection element without the third frontal plane of the locking element contacting the first frontal plane of the first connection element and/or the second frontal plane of the second connection element. The distance thus prevents force or momentum transfer from the locking element to the first and/or connection element. Without this force or momentum transfer, the first and second connection element is not forced apart, and the storage container is not forced open. The configuration according to the invention means that the closure device cannot be opened in an unwanted manner in the event of the storage container being dropped.

According to an advantageous embodiment of the present invention, it can be possible for the locking element to contain a first end, a second end, a first side wall and a second side wall which, together with the third frontal plane, form a concave inner surface in which the first and second connection element can be received, and wherein the first end, the second end, the first side wall and the second side wall each has a distance from the first and second connection element when the locking element is situated in the locking position. This makes it possible to effectively prevent a situation in which force or momentum action on the locking element is transmitted to the first and/or second connection element and the first and second connection element are forced apart as a result.

According to a further advantageous embodiment of the present invention, it can be possible for the first connection element to contain a first constituent part of a latching closure and for the locking element to contain a second constituent part of the latching closure, with the result that the locking element can assume a releasable connection with the first connection element. The use of a latching closure allows a closure for the storage container to be provided in a simple and cost-effective manner.

According to a further advantageous embodiment of the present invention, it can be possible for the first connection element to contain an elevation having a substantially rectangular cross-sectional area and for the second connection element to contain a depression, which corresponds to the elevation, having a substantially rectangular cross-sectional area, wherein the elevation can be at least partially received in the depression when the first connection element bears against the second connection element. This makes it possible to ensure a precise fit between the first connection element and the second connection element when the first connection element bears against the second connection element.

Furthermore, the present invention provides a storage container, in particular a case, having at least one closure device.

Further advantages will become apparent from the following description of the figures. Various exemplary embodiments of the present invention are illustrated in the figures. The figures, the description and the claims contain numerous features in combination. A person skilled in the art will expediently also consider the features individually and combine them to produce expedient further combinations.

### BRIEF DESCRIPTION OF THE DRAWINGS

In the figures, identical components and components of identical type are designated by the same reference signs. In the figures:

FIG. 1 shows a perspective view of a storage container according to the invention in the configuration of a case having a first and second connection device according to the invention;

FIG. 2 shows a perspective view of a first and second connection element of the closure device according to the invention;

FIG. 3 shows a perspective view of the first connection element;

FIG. 4 shows a perspective view of the second connection element;

FIG. 5 shows a perspective view of the first connection element, second connection element and a locking element of the closure device according to the invention;

FIG. 6 shows a perspective sectional view of the first connection element, second connection element and the locking element of the closure device according to the invention; and

FIG. 7 shows a further perspective sectional view of the first connection element, second connection element and the locking element of the closure device according to the invention.

### DETAILED DESCRIPTION

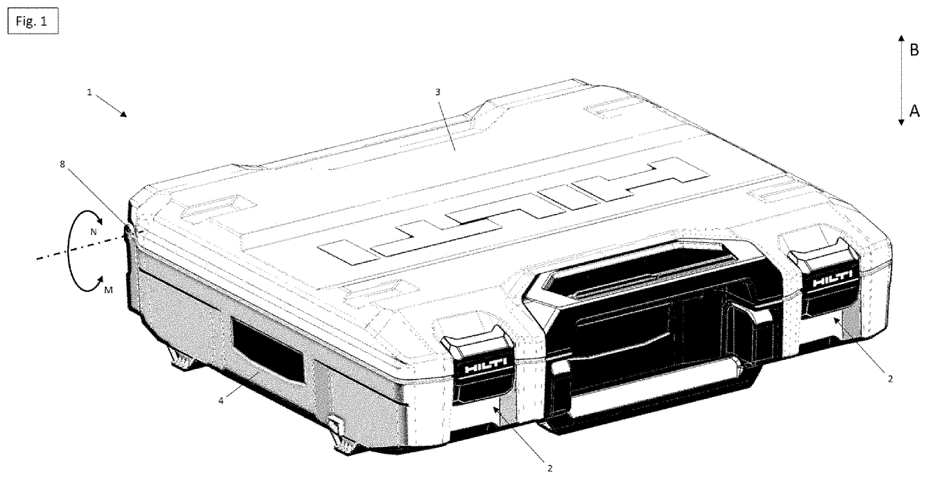

FIG. 1 shows a perspective view of a storage container 1 according to the invention in the configuration of a case having a first and second closure device 2 according to the invention.

The storage container 1 configured as a case substantially contains a cover element 3, a base element 4, a first connection element 5, a second connection element 6 and a locking element 7.

Both the cover element 3 and the base element 4 are each substantially configured as a shell. In order to form a cavity or storage space between the cover element 3 and the base element 4, the concave inner sides of the cover element 3 and of the base element 4 point toward one another. In order for the storage container 1 configured as a case to be able to be opened and closed again, a hinge 8 is provided on the rear side of the cover element 3 and of the base element 4. The hinge 8 allows reversible pivoting of the cover element 3 relative to the base element 4 in arrow direction N or M.

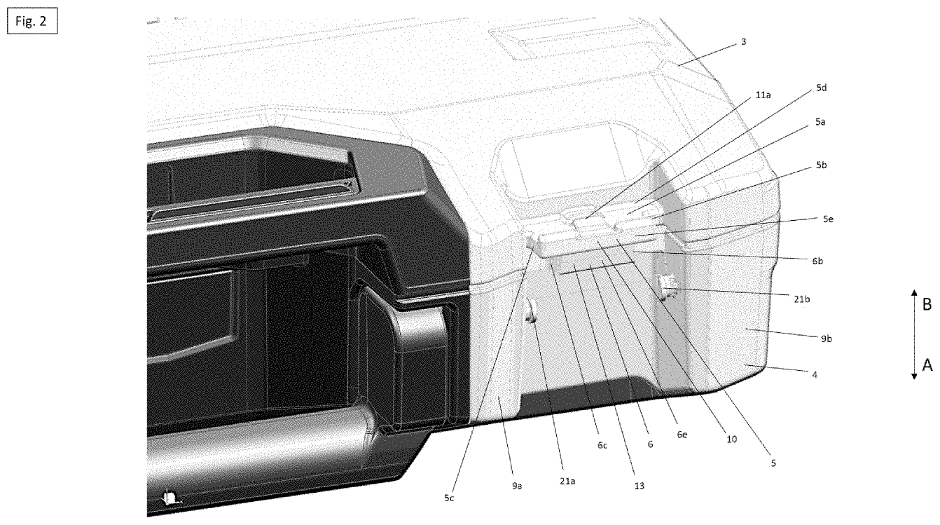

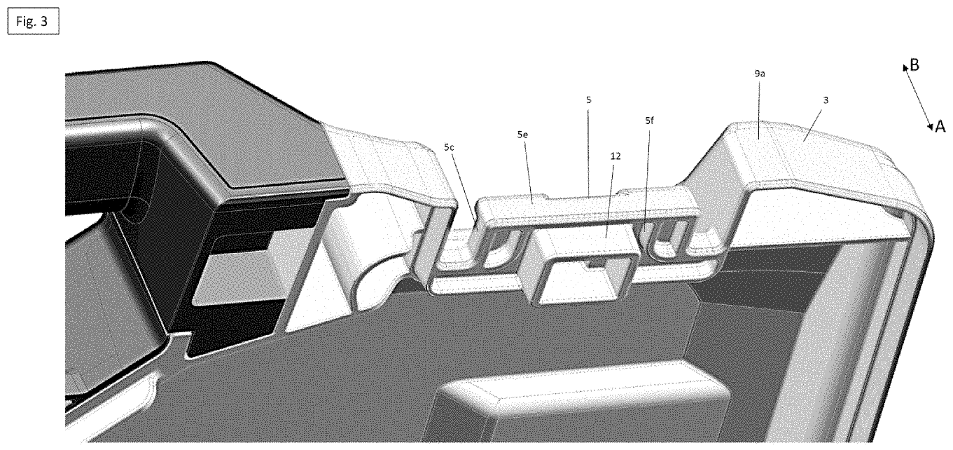

As shown in particular in FIGS. 2 and 3, the first connection element 5 of the closure device 2 is positioned on a front side of the cover element 3.

Here, the first connection element 5 is substantially configured as a flat elevation or plate which extends perpendicularly (or orthogonally) from a frontal plane of the front side 9a of the storage container 1. Here, the first connection element 5 configured as a flat elevation or plate contains a surface 5a, a first side face 5b, a second side face 5c, a rear side 5d, a front side 5e and a bottom face 5f. The first connection element 5 is firmly connected by the rear side 5d to the front side 9a of the storage container 1. A first frontal plane 10 extends along the front side 5e of the first connection element 5. Here, the first frontal plane 10 is arranged or oriented substantially parallel to the front side 9a of the storage container 2.

Furthermore, a first constituent part 11a of a latching closure 11 rises in a central position from the surface 5a of the first connection element 5. The first constituent part 11a of the latching closure 11 is substantially configured as a surface or ramp which rises in direction. As will be described below, a second constituent part 11b of the latching closure 11 is positioned on the locking element 7.

Moreover, the first connection element 5 contains an elevation 12 having a substantially rectangular cross-sectional area (cf. FIG. 3). The elevation 12 extends in a direction A from the bottom face 5f of the first connection element 5.

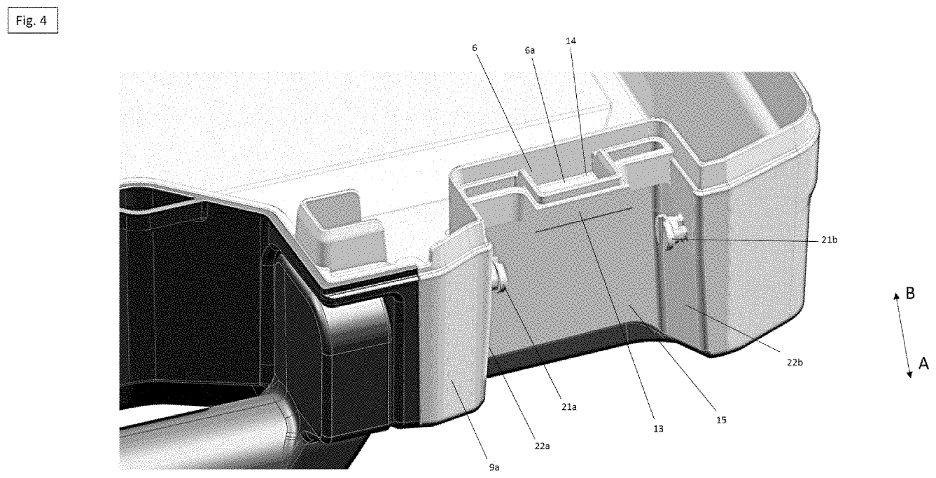

As shown in particular in FIGS. 2 and 4, the second connection element 6 of the closure device 2 is positioned on a front side 9b of the base element 4.

Here, the second connection element 6 is likewise substantially configured as a flat elevation or plate which extends perpendicularly (or orthogonally) from a frontal plane of the front side 9a of the storage container 1. Here, the second connection element 6 configured as a flat elevation or plate contains a surface 6a, a first side face 6b, a second side face 6c, a rear side 6d, a front side 6e and a bottom face 6f. The second connection element 6 is firmly connected by the rear side 6d to the front side 9a of the storage container 1. A second frontal plane 13 extends along the front side 6e of the second connection element 6. Here, the second frontal plane 13 is arranged or oriented substantially parallel to the front side 9a of the storage container 1.

Moreover, the second connection element 6 contains a depression 14, which corresponds to the elevation 12 of the first connection element, having a substantially rectangular cross-sectional area (cf. FIG. 3). The depression 14 extends in a direction B from the bottom face 6f of the second connection element 6.

Here, the elevation 12 of the first connection element 5 and the depression 14 of the second connection element 6 are each configured in such a way that the elevation 12 can be received in the depression 14.

The first and second connection element 5, 6 of the closure device 2 are arranged in a recess 15 on the front side 9a of the storage container 1 configured as a case. The recess 15 serves to place the closure device 2 in a depression on the front side 9a of the storage container 1 and to expose the closure device 2 less pronouncedly to possible force influences and damage that could act on the closure device 2 as a result of said container being dropped.

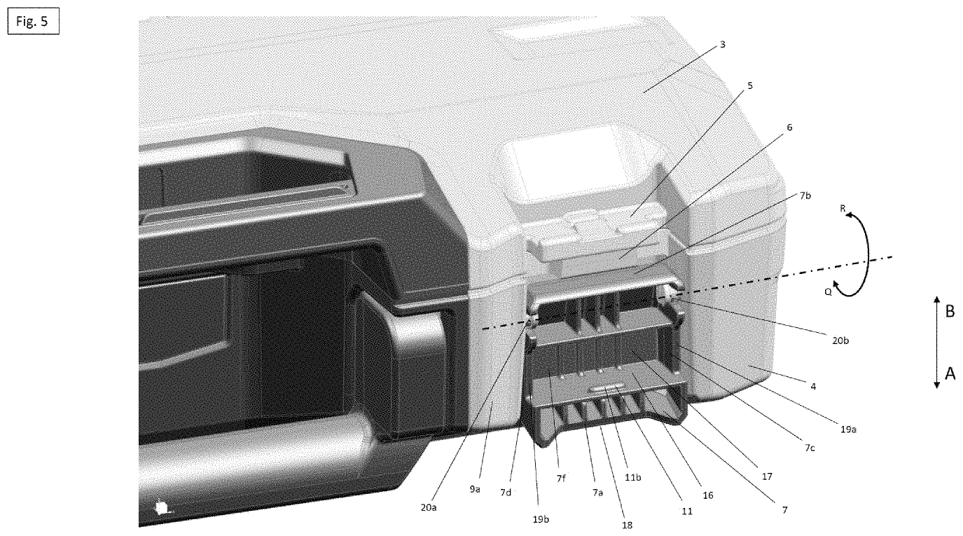

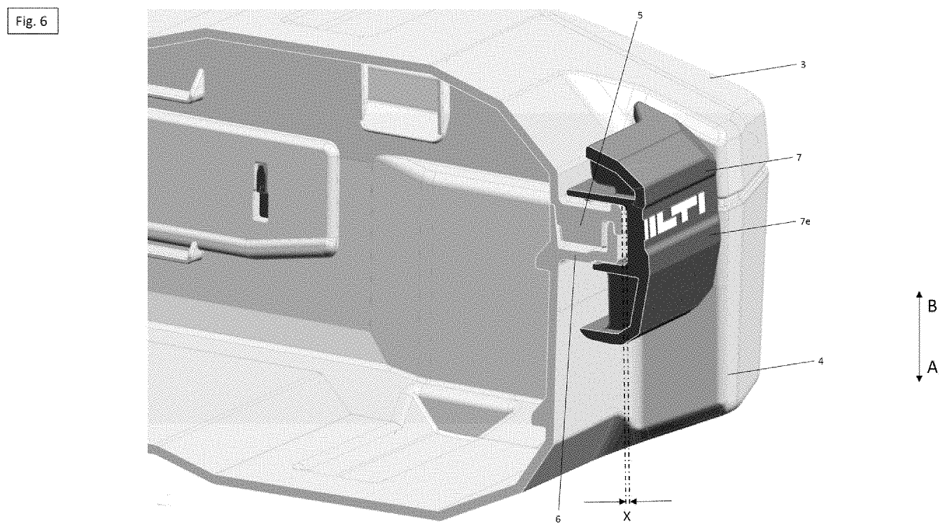

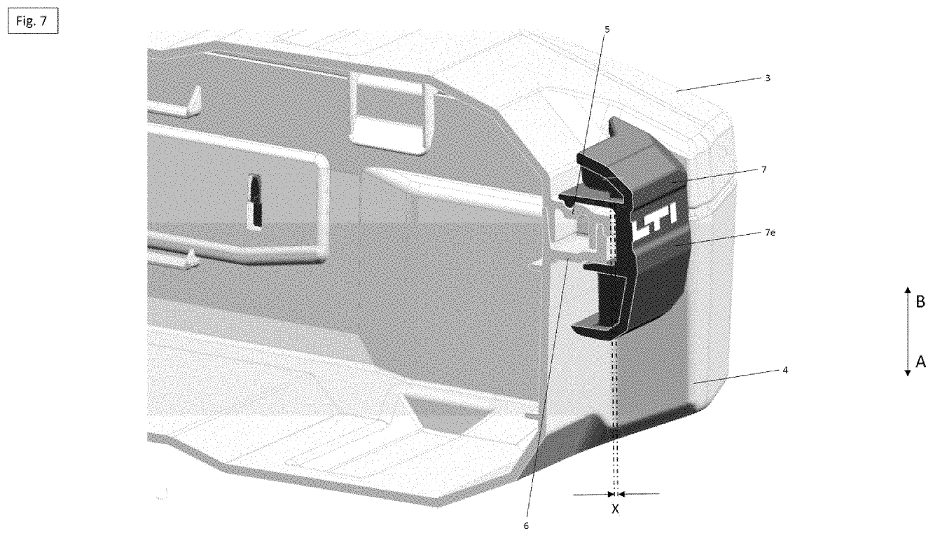

As illustrated in FIGS. 5 to 7, the locking element 7 is configured substantially in the form of a flap. The flap and in particular with respect to the function of the locking element 7, the flap can also be referred to as a clasp. The locking element 7 configured as a flap contains a first end 7a, a second end 7b, a first side wall 7c, a second side wall 7d, a front side 7e and a rear side 7f. The locking element 7 is thus configured overall as a shell. The rear side and the two side walls 7c, 7d together form a concave inner surface 16 on the locking element 7. The rear side 7f additionally contains a third frontal plane 17.

On the first end 7a of the locking element there is positioned a recess 18 on which a user can exert a certain degree of force on the locking element 7 in order to move the locking element 7 from a locking position into a release position. Both the locking position and the release position of the locking element 7 will be described in further detail below.

Furthermore, the first side wall 7c contains a first side wall recess 19a, and the second side wall 7d contains a second side wall recess 19b.

On the second end 7b of the locking element 7 there is provided, on opposite sides, a respective first and second semicircular cutout 20a, 20b. The first and second cutout 20a, 20b serves as a bearing for a first and second axis of rotation 21a, 21b. The first and second axis of rotation 21a, 21b are positioned oppositely on the first and second wall 22a, 22b of the depression on the front side 9a of the storage container 1 (cf. FIGS. 2 and 4). Furthermore, the two axes of rotation 21a, 21b are fastened to the base element 4. The cutouts 20a, 20b serving as bearings correspondingly engage around the axes of rotation 21a, 21b in such a way that the locking element 7 can be pivoted about the axes of rotation 21a, 21b in arrow direction q or R. Here, the locking element 7 is pivotably mounted on the base element 4 by the second end 7b in such a way that the concave inner surface 16 engages around the first and second connection element 5, 6 when the locking element 7 is situated in the locking position.

FIG. 5 illustrates the storage container 1 configured as a case with the closure devices 2 in a release position. When the closure devices 2 are situated in the release position, the cover element 3 having the first connection element 5 can be pivoted away from the base element 4 having the second connection element 6 with the aid of the hinge 8, and the storage container 1 can thus be opened. Opening the storage container 1 makes the cavity between the cover element 3 and the base element 4 accessible. As can be gathered from FIG. 5, the front side 7e of the locking element 7 bears against the front side 9a of the storage container 1. Here, the concave inner surface 16 of the locking element 7 faces outward and away from the storage container 1.

FIG. 1 shows the storage container 1 configured as a case with the closure devices 2 in a locking position. Here, the locking element 7 bears against the front side 9a of the storage container 2 in such a way that the front side 7e of the locking element 7 lies substantially parallel to a plane of the front side 9a of the storage container 2. The rear side 7f of the locking element 7 lies with the third frontal plane 17 at a certain distance X both from the first frontal plane 10 of the first connection element 5 and from the second frontal plane 13 of the second connection element 6. Here, the distance X is between 2 and 10 mm. The distance X is chosen such that, with a sudden action of force on the closure device 2 as a result of the storage container 1 being dropped onto a hard surface, the locking element 7 can undergo a certain deformation or a certain movement (without a deformation of the locking element) in the direction of the first and second connection element 5, 6 without the third frontal plane 17 of the locking element 7 contacting the first frontal plane 10 of the first connection element 5 and/or the second frontal plane 13 of the second connection element 6. The distance X thus prevents force or momentum transfer from the locking element 7 to the first and/or connection element 5, 6. Without this force or momentum transfer, the first and second connection element 5, 6 are not forced apart, and the storage container 1 is not forced open. The configuration according to the invention means that the closure device 2 cannot be opened in an unwanted manner in the event of the storage container being dropped.

### OVERVIEW OF THE REFERENCE SIGNS

1 storage container
2 closure device
3 cover element
4 base element
5 first connection element
5a surface
5b first side face
5c second side face
5d rear side
5e front side
5f bottom face
6 second connection element
6a surface
6b first side face
6c second side face
6d rear side
6e front side
6f bottom face
7 locking element
7a first end
7b second end
7c first side wall
7d second side wall
7e front side
7f rear side
8 hinge
9a front side of the storage container
9b front side of the base element
10 first frontal plane
11 latching closure
11a first constituent part of the latching closure
11b second constituent part of the latching closure
12 elevation of the first connection element
13 second frontal plane
14 depression of the second connection element
15 recess on the front side of the storage container
16 concave inner surface
17 third frontal plane
18 recess on locking element
19a first side wall recess
19b second side wall recess
20a first semicircular cutout
20b second semicircular cutout
21a first axis of rotation
21b second axis of rotation
22a first wall
22b second wall

What is claimed is:

1-5. (canceled)

6. A closure device for a storage container, the closure device comprising:
a cover element;
a base element;
a first connection element;
a second connection element; and
a locking element, wherein the first connection element is positioned on the cover element and the second connection element is positioned on the base element in such a way that the first and second connection element at least partially bear against one another when the cover element and the base element bear against one another to close the storage container, the locking element being positionable on the base element reversibly in a locking position or release position, wherein, in the locking position, separation of the first connection element from the second connection element is prevented, and, in the release position, separation of the first connection element from the second connection element is allowed;
the first connection element having a first frontal plane, the second connection element having a second frontal plane, and the locking element having a third frontal plane, the first and second frontal plane being oriented parallel to one another and the third frontal plane having a distance from the first and second frontal plane when the locking element is situated in the locking position.

7. The closure device as recited in claim 6 wherein the locking element includes a first end, a second end, a first side wall and a second side wall, forming, together with the third frontal plane, a concave inner surface, the first and second connection element being receivable in the concave inner surface, and the first end, the second end, the first side wall and the second side wall each having a distance from the first and second connection element when the locking element is situated in the locking position.

8. The closure device as recited in claim 6 wherein the first connection element defines a first constituent part of a latching closure, and the locking element defines a second constituent part of the latching closure, the locking element being releasable with respect to the first connection element.

9. The closure device as recited in claim 6 wherein the first connection element includes an elevation having a rectangular cross-sectional area, and the second connection element contains a depression corresponding to the elevation and having a further rectangular cross-sectional area, the elevation at least partially receivable in the depression when the first connection element bears against the second connection element.

10. A storage container comprising the closure device as recited in claim 6.

11. A case comprising the closure device as recited in claim 6.
